(19) United States
(12) Patent Application Publication
(10) Pub. No.: US 2024/0111596 A1
(43) Pub. Date: Apr. 4, 2024

(54) Quality-of-Service Partition Configuration

(71) Applicants: Advanced Micro Devices, Inc, Santa Clara, CA (US); ATI Technologies ULC, Markham (CA)

(72) Inventors: Tung Chuen Kwong, Richmond Hill (CA); King Chiu Tam, Vaughan (CA); Akila Subramaniam, Allen, TX (US)

(21) Appl. No.: 17/955,613

(22) Filed: Sep. 29, 2022

(51) Int. Cl. G06F 9/50; G06F 9/54

(52) U.S. Cl. CPC G06F 9/505; G06F 9/542

(57) ABSTRACT

A scheduler of an apparatus exposes an application programming interface (API) usable to specify quality-of-service (QoS) parameters, e.g., latency, throughput, and so forth. An application, for instance, specifies the QoS parameters for a workload to be processed using a hardware compute unit. The QoS parameters are employed by the scheduler as a basis to configure a partition within a hardware compute unit. The partition is configured such that processing resources that are available via the partition to process the workload comply with the specified quality-of-service.

### BACKGROUND

Hardware device design is continually optimized and expanded to increase functionality made available by computing devices. Applications that are executed by the computing devices, however, have limited insight in how to access and control this functionality. This has resulted in inefficient use and suboptimal power consumption caused in the execution of these applications, especially when time sensitive. In real-time execution scenarios, for instance, conventional scheduling techniques experience resource degradation and latency when confronted with numerous real-time workload requests in conjunction with attempts to maximize available resources for each of the requests.

### BRIEF DESCRIPTION OF THE DRAWINGS

The detailed description is described with reference to the accompanying figures.

FIG. 1 is a block diagram of a non-limiting example of a device configured to implement quality-of-service partition configuration techniques.

FIG. 2 is a block diagram of a non-limiting example showing operation of a scheduler of FIG. 1 in greater detail to implement quality-of-service partition configuration techniques.

FIG. 3 is a block diagram of a non-limiting example of a system showing operation of a compute array of FIG. 1 as implementing partitions for execution of respective machine-learning models.

FIG. 4 is a block diagram of a non-limiting example of a system showing configuration of a plurality of partitions for first and second applications based on quality-of-service (QoS) considerations.

FIG. 5 depicts a procedure in an example implementation of quality-of-service (QoS) partition configuration.

### DETAILED DESCRIPTION

Hardware design continually evolves to provide ever increasing amounts and varieties of functionality in support of corresponding increases in application functionality. As a result, scheduling execution of workloads from the applications using various hardware designs has also experienced a corresponding increase in complexity, which in some instances hinders device operation. For example, priority is usable to differentiate between real time versus non-real time workloads. However, in real-world scenarios applications typically default to “real time,” which results in multiple workload requests that cause service degradation. In another example, high-level hints are used to indicate desired modes of operation but do not provide insight into actual resource utilization and goals involving in processing a corresponding workload. This often results in overallocation of resources, a corresponding increase in power consumption, and thus inefficient operation of devices that utilize these resources.

To solve these problems, a scheduler of an apparatus (e.g., an inference accelerator) exposes an application programming interface (API) usable to specify quality-of-service (QoS) parameters, e.g., latency, throughput, and so forth. An application, for instance, specifies the QoS parameters for a workload to be processed using a hardware compute unit. In an example involving image processing, the QoS parameters specify real time at thirty frames per second with a thirty-millisecond latency for use in object recognition by a machine-learning model executed by the hardware compute unit.

The QoS parameters are employed by the scheduler as a basis to configure a partition within a hardware compute unit, e.g., a compute array having a plurality of columns to implement the machine-learning model. The partition is configured such that processing resources that are available via the partition to process the workload comply with the specified quality-of-service. The scheduler, for instance, configures the partition to have enough processing resources (e.g., columns in a compute array and clock speed to implement the machine-learning model) to support the quality-of-service parameters. This improves device operation through targeted optimization of computational resources and reduces power consumption.

Other insights are also usable by the scheduler to configure the partition. In one such example, workload statistics are used that describe characteristics involved in processing the workload, e.g., a number of operations to be performed, data movement between layers of a machine-learning model, and so forth. The workload statistics, for instance, are obtained from heuristics generated from prior knowledge of hardware and/or firmware for the machine-learning model.

In another example, operation data is employed by the scheduler as part of configuring the partition. The operation data, for instance, describes operation of the hardware compute unit, e.g., resource consumption by other partitions, partition availability, temperature, power usage, and so forth. In this way, operation of the hardware compute unit is optimized by the scheduler based on insight gained into a workload to be processed. A variety of other examples are also contemplated, further discussion of which is included in the following discussion and shown using corresponding figures.

In some aspects, the techniques described herein relate to a method including: receiving an input via an application programming interface from an application, the input specifying a quality-of-service (QoS) parameter for processing a workload associated with the application; determining a partition configuration of a hardware compute unit to process the workload, the determining based at least in part on the QoS parameter; generating a partition in the hardware compute unit having the determined partition configuration; and processing the workload from the application using the generated partition by the hardware compute unit.

In some aspects, the techniques described herein relate to a method, wherein the quality-of-service (QoS) parameter defines latency or throughput.

In some aspects, the techniques described herein relate to a method, wherein the determining the partition configuration includes determining a size or clock speed of the hardware compute unit to meet the quality-of-service (QoS) parameter.

In some aspects, the techniques described herein relate to a method, wherein the determining the size includes determining a number of columns in a compute array of the hardware compute unit to be used to process the workload.

In some aspects, the techniques described herein relate to a method, further including receiving workload statistics describing the workload and wherein the determining of the partition configuration is based at least in part on the QoS parameters and the workload statistics.

In some aspects, the techniques described herein relate to a method, wherein the workload statistics include a number of operations or data movement.

In some aspects, the techniques described herein relate to a method, wherein the workload statistics are determined based on prior knowledge of implementation of the workload.

In some aspects, the techniques described herein relate to a method, wherein the workload includes execution of a machine-learning model selected from a plurality of precompiled machine-learning models.

In some aspects, the techniques described herein relate to a method, further including receiving operation data describing operation of the hardware compute unit and wherein the determining of the partition configuration is based at least in part on the QoS parameters and the operation data.

In some aspects, the techniques described herein relate to a method, wherein the operation data describes operation of another partition by the hardware compute unit.

In some aspects, the techniques described herein relate to a device including: a hardware compute unit; and a scheduler configured to: expose an API that is accessible by an application to specify a quality-of-service (QoS) parameter for processing a workload; and configure a partition in the hardware compute unit to process the workload based at least in part of the quality-of-service (QoS) parameter.

In some aspects, the techniques described herein relate to a device, wherein the quality-of-service (QoS) parameter defines latency or throughput.

In some aspects, the techniques described herein relate to a device, wherein the scheduler is configured to configure the partition based on a determination of a size or clock speed of the hardware compute unit to meet the quality-of-service (QoS) parameter.

In some aspects, the techniques described herein relate to a device, wherein the scheduler is configured to determine the size as a number of columns in a compute array of the hardware compute unit to be used to process the workload.

In some aspects, the techniques described herein relate to a device, wherein the scheduler is configured to receive workload statistics describing the workload and configure the partition based at least in part on the quality-of-service QoS parameter and the workload statistics.

In some aspects, the techniques described herein relate to a device, wherein the workload statistics include a number of operations and data movement.

In some aspects, the techniques described herein relate to a device, wherein the scheduler is configured to receive operation data describing operation of the hardware compute unit and configure the partition based at least in part on the quality-of-service (QoS) parameter and the operation data.

In some aspects, the techniques described herein relate to a device, wherein the scheduler is configured to configure the partition to minimize power consumption in processing the workload and comply with the quality-of-service parameter.

In some aspects, the techniques described herein relate to a method including: receiving an input via an application programming interface from an application, the input specifying a quality-of-service (QoS) parameter and workload statistics for processing a workload associated with the application; determining a partition configuration of a hardware compute unit to process the workload, the determining configured to minimize power consumption in processing the workload based on the workload statistics in compliance with the QoS parameter; generating a partition in the hardware compute unit having the determined partition configuration; and processing the workload from the application using the generated partition by the hardware compute unit.

In some aspects, the techniques described herein relate to a method, wherein: the quality-of-service (QoS) parameter defines latency or throughput; and the workload statistics include a number of operations or data movement.

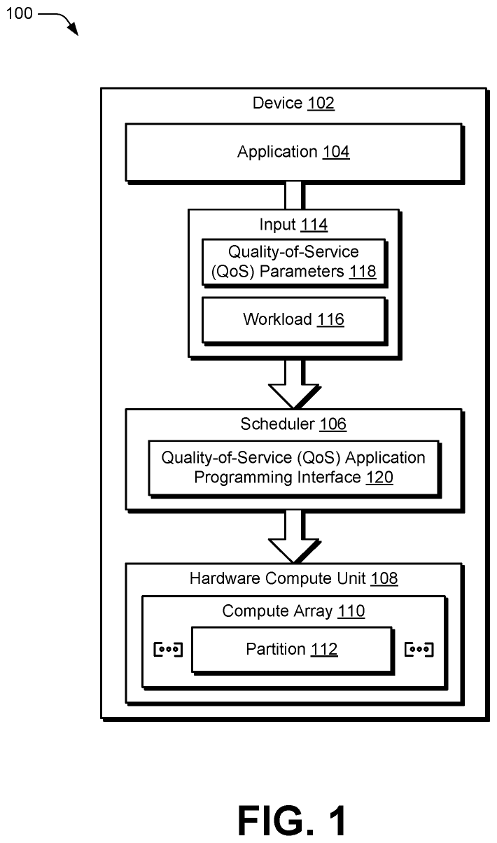

FIG. 1 is a block diagram of a non-limiting example 100 of a device 102 configured to implement quality-of-service partition configuration techniques. These techniques are usable by a wide range of device 102 configurations. Examples of those devices include, by way of example and not limitation, computing devices, servers, mobile devices (e.g., wearables, mobile phones, tablets, laptops), processors (e.g., graphics processing units, central processing units, and accelerators), digital signal processors, interference accelerators, disk array controllers, hard disk drive host adapters, memory cards, solid-state drives, wireless communications hardware connections, Ethernet hardware connections, switches, bridges, network interface controllers, mobile phones, tablets and other apparatus configurations. It is to be appreciated that in various implementations, the techniques described herein are usable using any one or more of those devices listed just above and/or a variety of other devices without departing from the spirit or scope of the described techniques.

The illustrated example of the device 102 includes an application 104, a scheduler 106, and a hardware compute unit 108. The application 104 is representative of any form of software configurable as instructions that are executable by a processing device (e.g., central processing unit, parallel processing unit, etc.) to perform operations.

The scheduler 106 is representative of functionality to schedule and thus control execution of the code to perform operations by the hardware compute unit 108. The application 104, for instance, is executable by a central processing unit and the hardware compute unit 108 is configurable as a system-on-a-chip (SoC), parallel processor (e.g., graphics processing unit, inference processor), and so forth. The CPU and the SoC are communicatively coupled, e.g., via a bus.

In the illustrated example, the hardware compute unit 108 is configured as a compute array 110 having circuitry that is individually powered and clocked. By leveraging this functionality, partitions 112 are formable in the hardware compute unit 108 as hardware dedicated to a particular function, e.g., to separate execution of instructions of one application from another application, etc. To do so, the scheduler 106 specifies configuration of the partition 112 in the hardware compute unit 108. Configuration of the partition 112 includes a variety of functionality, including an ability to specify particular hardware, amount of processing resources, clock speeds, and so forth to be used in execution of the instructions.

An input 114, for instance, is received by the scheduler 106 from an application 104. The input 114 specifies a workload 116, e.g., collection of instructions, data, and so forth. In response, the scheduler 106 configures a partition 112 in the compute array 110 to process the workload 116, a result of which is returned to the application 104.

As previously described, however, conventional scheduling techniques lack insight into characteristics of processing for the workload. Consequently, conventional techniques are challenged when striking a balance between over allocation of resources and corresponding inefficient use of computational and power resources of the device 102 and under allocation of resources and lack of an ability to provide sufficient processing of the workload.

To address these challenges, the scheduler 106 exposes a quality-of-service (QoS) application programming interface (hereinafter referred to as QoS API 120) that permits the application 104 to specify quality-of-service (QoS) parameters 118 for processing the workload 116. The scheduler 106 then uses the QoS parameters 118 to configure the partition 112 to comply with these parameters, e.g., to provide sufficient processing resources from the compute array 110 such that processing of the workload 116 is performed as having the specified quality. In this way, the scheduler 106 configures the partition 112 to minimize power consumption in a manner that provides a desired amount of functionality as specified by the application 104 using the QoS parameters 118, thereby optimizing operation of the device 102.

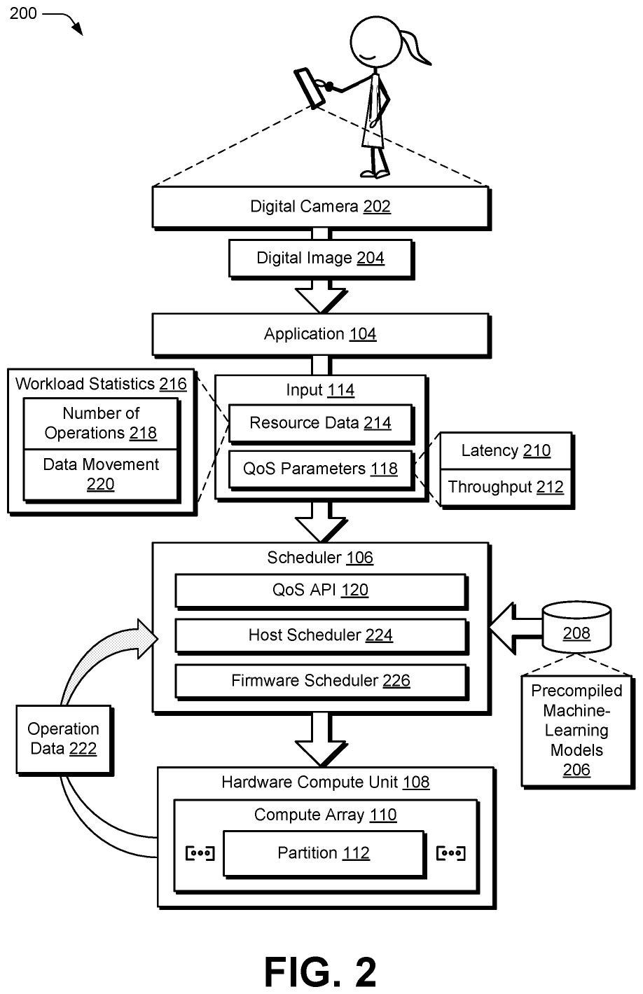

FIG. 2 is a block diagram of a non-limiting example 200 showing operation of a scheduler of FIG. 1 in greater detail to implement quality-of-service partition configuration techniques. In this example, the device 102 of FIG. 1 includes a digital camera 202 configured to capture digital images 204. The application 104 is then configured to leverage a machine-learning model to process the digital image 204, e.g., to perform object recognition, image correction, and so forth.

To do so, the application 104 provides an input 114 to the scheduler 106 to configure the partition 112 to implement the machine-learning model using a selected one of a plurality of precompiled machine learning modules 206 illustrated as available via storage 208. The input 114 includes QoS parameters 118 provided via the QoS API 120, examples of which include latency 210 and throughput 212. For processing a digital images 204, for instance, the parameters specify whether the workload is to be processed by the partition 112 in “real time” or “not real time” (i.e., “best effort”), a framerate (e.g., thirty frames-per-second), and an amount of time for “latency” permitted in processing the workload, e.g., thirty milliseconds latency.

The input 114 in this example also includes resource data 214 which provides insights into resources to be utilized in processing the workload 116. The workload 116 is this example is deterministic and by leveraging this the resource data 214 includes workload statistics 216 that are determined and characterized during a compilation stage in generating the precompiled machine-learning models 206. The workload statistics 216 are configurable as a serialized graph representation that describes resource consumption by the machine-learning models, e.g., a number of operations 218, data movement 220 between layers of the model, and so forth. The scheduler 106 is thus configured in this example to utilize indications of quality by the QoS parameters 118 along with the workload statistics 216 to determine a minimum amount of computational resources to be allocated from the compute array 110 to form the partition 112.

The scheduler 106 is also configured to take into account a variety of other information as part of configuring the partition 112. An example of this is illustrated as operation data 222 that describes operation of the hardware compute unit 108. The operation data 222, for instance, describes a power state (e.g., current power consumption), available resources, resources consumed by other partitions, partition sharing, temperature, active sessions, and so forth. In this way, the scheduler 106 is also configured to leverage insight into operation of the hardware compute unit 108 itself as part of configuring the partition 112.

In the illustrated example, the scheduler 106 is executed during preparation of the machine-learning models, model closing, system power events, and internal refresh events. Otherwise, the scheduler 106 is not executed (e.g., during inferences) to minimize scheduling overhead. Functionality of the scheduler 106 is divided into a host scheduler 224 and a firmware scheduler 226. The host scheduler 224 is responsible for dispatch queue and partition management. The firmware scheduler 226 is responsible for priority dispatch and preemption.

The scheduler 106 uses the QoS parameters 118 received via the QoS API 120 and model complexity as defined by the resource data 214 to determine resources involves for a given inference session. The scheduler 106 also leverages operation data 222 describing resources utilized by other active sessions and system power state to determine an optimal partition configuration for the workload, e.g., as an active inference session. This is performable in a variety of ways, such as by utilizing a first-come-first-served technique, a global load balancing technique, and so forth.

In a scenario in which a priority is specified, e.g., “real time” or “not real time,” real time QoS priority is higher than that of a “not real time” priority, i.e., “best effort” priority. Examples of QoS parameters 118 for real-time priority include frame-per-second, latency, and priority. QoS parameters 118 for not-real-time priority specify the priority, alone.

In order to schedule a real-time priority session, the scheduler 106 locates a next available partition having a sufficient amount of computational resources, e.g., based on the QoS parameters 118, workload statistics 216, and/or operation data 222. If the partition is currently assigned for use in a “not real time” session, the scheduler 106 flushes queues associated with the partition and reconfigures the partition for this new session, and reschedules the original “not real time” (i.e., “best effort”) session. In an instance in which a free partition is not available, model preparation fails because the specified QoS cannot be met.

For a “not real time” priority session, the scheduler 106 finds a next available partition according to a system power state specified in the operation data 222. For example, in a low-power mode the scheduler 106 gives preference to a smaller partition size, whereas in a performance mode the scheduler 106 gives preference to a larger partition size. Similarly, in a low-power mode, the scheduler 106 institutes partition sharing with other “not real time” priority sessions.

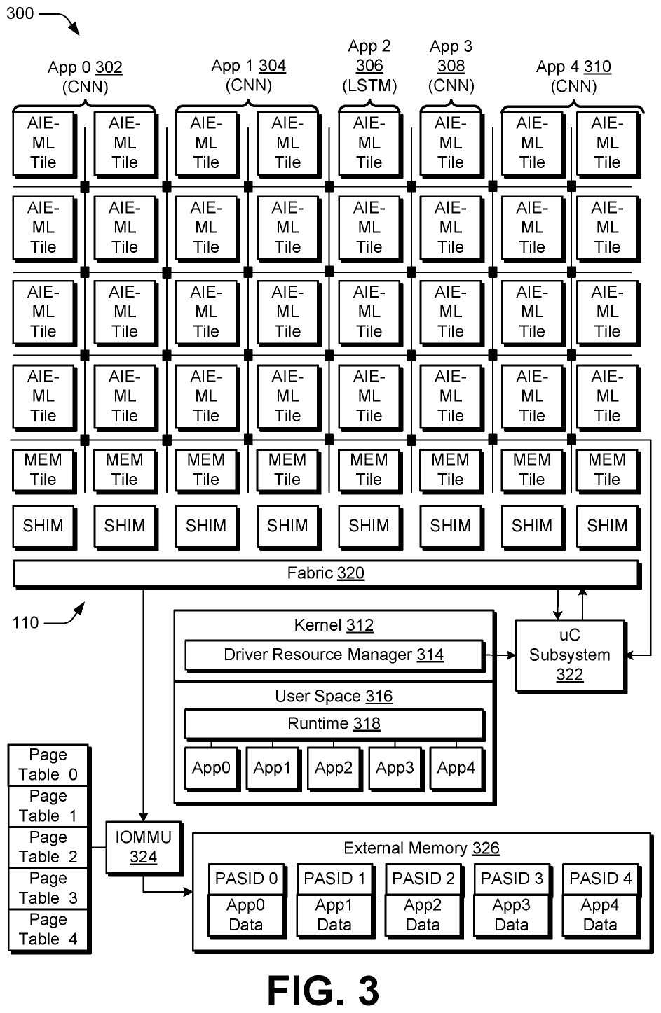

FIG. 3 is a block diagram of a non-limiting example 300 of a system showing operation of the compute array 110 as implementing partitions for execution of respective machine-learning models. Hardware resources of the compute array are arranged in a plurality of columns, the illustrated example of which includes eight columns. Partitions are formed corresponding to respective applications, examples of which include app 0 302, app 1 304, app 2 306, app 3 308, and app 4 310. A partition for app 0 302, for instance, is used to execute a convolutional neural network (CNN) using two columns. A partition for app 1 304 also uses two columns to execute a CNN. App 2 306, on the other hand, implements a long short-term memory (LSTM) model using a single column. App 3 308 implements a CNN using a single column and app 4 310 implements a CNN using two columns of the compute array 110.

The system includes a kernel 312 executing a driver resource manager 314 and a user space 316 including a runtime 318. The driver resource manager 314 is connected to a fabric 320 of the compute array 110 via a uC subsystem 322. An input/output memory management unit (IOMMU) 324 is used to connect a direct memory access capable input/output bus to main memory, which is illustrated as external memory 326. Data corresponding to respective applications in the external memory 326 is arranged using respective process address space identifiers (PASIDs).

In an implementation, the QoS API 120 includes the following functionality in a machine-learning model scenario:
rmlCreateContext—context of different application processes are isolated by different process address spec ID's (PASID);
rlmLoadModel (i.e., rmlLoadGraphFromFile/RMLCreateModelFromGraph);
mlLoadMo del (i.e., rmlLoadGraphFromFile/rmlCreateModelFromGraph)—load/create model from a pre-compiled model container, e.g., storage 208;
rmlSetModelQos (for the QoS parameters 118), QoS is divided into two classes:
   “not real time” (i.e., “best-effort”) (default), and “real time;”
   “real-time” QoS parameters: frame-per-second (or period), latency, priority;
   “not real time” QoS parameters: priority;
rmlPrepareModel—Allocate compute resource to meet the specified QoS and update power management;
rmlInfer—Enqueue prepared model to allocated compute resource;
rmlCloseContext—release compute resource and update power management;
   As previously described, the precompiled machine-learning models 206 are stored in storage 208 implementing a pre-compiled model container. Accordingly, multiple pre-compiled models (e.g., one for each hardware configuration) are storable in this container. In an implementation, the models include metadata, e.g., specifying the resource data 214 such as the workload statistics 216 indicating a number of operations 218, data movement 220, and so forth.

The QoS API 120 supports a variety of different usage scenarios. In a first example, multiple concurrent applications are implemented by calling the API as follows:
CreateContext->app0;
LoadModel<-a convolutional neural network (CNN) model with 1/2/4-column configuration, 0.3 TOPS/frame;
SetModelQos<-real time, 30 frame-per-second (FPS), 30 ms latency;
PrepareModel->implement two columns to meet QoS, allocate columns 0-1;
Infer . . .
   CreateContext->app1;
   LoadModel<-a BERT machine-learning model with two-column configuration, 0.8 TOPS/frame (batch of 10 audio frames);
   SetModelQos<-real time, 10 FPS, 100 ms latency;
   PrepareModel->implement two columns to meet QoS, allocate columns 2-3;
   Infer . . .
      CreateContext->app2;
      LoadModel<-a long short-term memory (LSTM) machine-learning model with one-column configuration, four TOPS/frame;
      SetModelQos<-real time, 1 FPS, one second latency;
      PrepareModel->implement one column to meet QoS, allocate column 4-4;
      Infer . . .
         CreateContext->app3;
         LoadModel<-a convolutional neural network (CNN) model with 1/2/4-column configuration, 0.3 TOPS/frame;
         SetModelQos<-best effort;
         PrepareModel->implement one separate column to maintain QoS of existing use cases, allocate column 5-5;
         Infer . . .
         CreateContext->app4;
         LoadModel<-a convolutional neural network (CNN) model with 1/2/4-column configuration, 0.3 TOPS/frame;
         SetModelQos<-real time, 30 FPS, 30 ms latency;
         PrepareModel->implement two columns to meet QoS, allocate columns 6-7;
         Infer . . .

In a second example, a new model for a corresponding application is swapped with an existing model, which is implemented by calling the API as follows:
CreateContext->app0;
LoadModel<-a convolutional neural network (CNN) model with 1/2/4-column configuration, 0.3 TOPS/frame;
SetModelQos<-realtime, 30 FPS;
PrepareModel->implement two columns to meet QoS, allocate column 0-1;
Infer . . . ;
Infer;
LoadModel<-a convolutional neural network (CNN) model with 1/2/4 column configuration, 0.2 TOPS/frame;
PrepareModel<-current allocation meet QoS, update firmware instruction sequence, solely;
Infer . . .

In a third example, a number of concurrent applications is greater than a number of available partitions, which is implemented by calling the API as follows:
CreateContext->app0;
LoadModel<-a convolutional neural network (CNN) model with 1/2/4-column configuration, 0.3 TOPS/frame;
SetModelQos<-realtime, 30 FPS, 30 ms latency, low priority;
PrepareModel->implement two columns to meet QoS, allocate columns 0-1;
Infer . . .
   CreateContext->app1;
   LoadModel<-a BERT machine-learning model with 2-column configuration, 0.8 TOPS/frame (batch of 10 audio frames);
   SetModelQos<-real time, 10 FPS, 100 ms latency, low priority;
   PrepareModel->implement two columns to meet QoS, allocate columns 2-3;
   Infer . . .
      CreateContext->app2;
      LoadModel<-a LSTM model with one-column configuration, four TOPS/frame;
      SetModelQos<-real time, one FPS, one second latency;
      PrepareModel->implement one column to meet QoS, allocate column 4-4;
      Infer . . .
         CreateContext->app4;
         LoadModel<-a convolutional neural network (CNN) model with 1/2/4-column configuration, 0.3 TOPS/frame;
         SetModelQos<-real time, 30 FPS, 30 ms latency, low priority;
         PrepareModel->implement two columns to meet QoS, allocate columns 6-7;
         Infer . . .
         CreateContext->app3;
         LoadModel<-a convolutional neural network (CNN) model with 1/2/4-column configuration, 0.3 TOPS/frame;
         SetModelQos<-best effort, high priority;
         PrepareModel->implement one separate column to maintain QoS of existing use cases, allocate column 5-5;
         Infer . . .
         CreateContext->app5;
         LoadModel<-a convolutional neural network (CNN) model with 1/2/4-column configuration, 0.3 TOPS/frame;
         SetModelQos<-best effort, low priority;
         PrepareModel->implement one separate column to maintain QoS of existing use cases, share column 5-5 cooperatively;
         Infer . . .

In a fourth example, the QoS API 120 supports multiple priority levels, which is implemented by calling the API as follows:
CreateContext->app0;
LoadModel<-a convolutional neural network (CNN) model with 1/2/4-column configuration, 0.3 TOPS/frame;
SetModelQos<-realtime, 30 FPS, 30 ms latency, low priority;
PrepareModel->implement two columns to meet QoS, allocate columns 0-1;
Infer . . .
   CreateContext->app1;
   LoadModel<-a BERT machine-learning model with two-column configuration, 0.8 TOPS/frame (batch of 10 audio frames);
   SetModelQos<-realtime, 10 FPS, 100 ms latency, low priority;
   PrepareModel->implement two columns to meet QoS, allocate columns 2-3;
   Infer . . .
      CreateContext->app2;
      LoadModel<-an LSTM model with one-column configuration, 4 TOPS/frame;
      SetModelQos<-real time, one FPS, one second latency;
      PrepareModel->implement one column to meet QoS, allocate column 4-4;
      Infer . . .
         CreateContext->app4;
         LoadModel<-a convolutional neural network (CNN) model with 1/2/4-column configuration, 0.3 TOPS/frame;
         SetModelQos<-realtime, 30 FPS, 30 ms latency, low priority;
         PrepareModel->implement two columns to meet QoS, allocate columns 6-7;
         Infer . . .
         CreateContext->app3;
         LoadModel<-a convolutional neural network (CNN) model with 1/2/4-column configuration, 0.3 TOPS/frame;
         SetModelQos<-best effort, high priority;
         PrepareModel->implement one separate column to maintain QoS of existing use cases, allocate column 5-5;
         Infer . . .
         CreateContext->app5;
         LoadModel<-a convolutional neural network (CNN) model with 1/2/4-column configuration, 0.3 TOPS/frame;
         SetModelQos<-best effort, low priority;
         PrepareModel->implement one separate column to maintain QoS of existing use cases, share column 5-5 cooperatively;
         Infer . . .

In a fifth example, the QoS API 120 supports dynamic partitions. In this example, instead of static assignment of columns, the configurations are dynamically resized. For examples, “app5” request sixty FPS and fifteen msec latency, which involves a four-column partition configuration. Accordingly, the partitions are reconfigured in this example to use columns 0-3 with partitions 0 and 2 being idle by calling the API as follows:
CreateContext->app0;
LoadModel<-a convolutional neural network (CNN) model with 1/2/4-column configuration, 0.3 TOPS/frame;
SetModelQos<-real time, 30 FPS, 30 ms latency;
PrepareModel->implement two columns to meet QoS, allocate columns 0-1;
Infer;
CloseContext->release & PG column 0-1;
   CreateContext->app1;
   LoadModel<-a BERT machine-learning model with two-column configuration, 0.8 TOPS/frame (batch of 10 audio frames);
   SetModelQos<-realtime, 10 FPS, 100 ms latency;
   PrepareModel->implement two columns to meet QoS, allocate columns 2-3;
   Infer;
   CloseContext->release & PG column 2-3;
      CreateContext->app2;
      LoadModel<-an LSTM machine-learning model with one-column configuration, four TOPS/frame;
      SetModelQos<-realtime, one FPS, one second latency;
      PrepareModel->implement one column to meet QoS, allocate column 4-4;
      Infer CloseContext->release & PG column 4;
         CreateContext->app4;
         LoadModel<-a convolutional neural network (CNN) model with 1/2/4-column configuration, 0.3 TOPS/frame;
         SetModelQos<-realtime, 30 FPS, 30 ms latency;
         PrepareModel->implement two columns to meet QoS, allocate columns 6-7;
         Infer . . .
         CreateContext->app3;
         LoadModel<-a convolutional neural network (CNN) model with 1/2/4-column configuration, 0.3 TOPS/frame;
         SetModelQos<-best effort;
         PrepareModel->implement one separate column to maintain QoS of existing use cases, allocate column 5-5;
         Infer . . .
         CreateContext->app5;
         LoadModel<-a convolutional neural network (CNN) model with 1/2/4-column configuration, 0.3 TOPS/frame;
         SetModelQos<-realtime, 60 FPS, 15 ms latency;
         PrepareModel->implement four separate columns to meet QoS, allocate columns 0-3;
         Infer

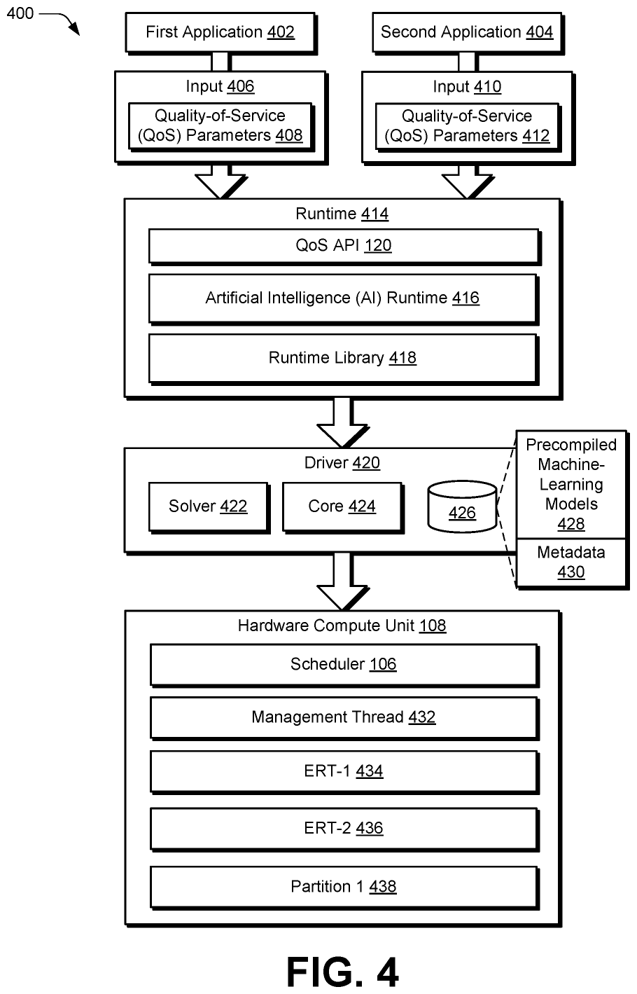

FIG. 4 is a block diagram of a non-limiting example 400 of a system showing configuration of a plurality of partitions for first and second applications 402, 404 based on quality-of-service (QoS) considerations. In this example, a software stack is shown implementing a runtime library that is usable in datacenter-based platforms, e.g., Xilinx Runtime Library (XRT) for PCIe-based platforms. The first application 402 provides an input 406 specifying quality-of-service (QoS) parameters 408 via the QoS API 120 to be used to configure a respective partition. The second application 404 also provides an input 410 specifying quality-of-service (QoS) parameter 412 via the QoS API 120 to be used to configure a respective partition.

The QoS API 120 is implemented in this example as part of a runtime 414 that includes an artificial intelligence (AI) runtime 416 and a runtime library 418. The runtime 414 communicates with a driver 420 having a solver 422, core 424, and memory 426 storing precompiled machine-learning models 428 and associated metadata 430, e.g., resource data 214. The hardware compute unit 108 implements the scheduler 106 as part of the stack and includes a management thread 432. ERT-1 434 and ERT-2 436 are firmware tasks. Partition 1 438 is utilized by the first and second applications 402, 404 in this example.

The first application 402, for instance, calls the QoS API 120 and provides the QoS parameters 408 along with workload statistics 216 as a serialized graph representation that specifies operation count and data movement. The solver 422 identifies a precompiled machine learning model 428, configures partition 1 428 as described above, and creates an associated firmware task represented as ERT-1 434.

A similar sequence is followed by the second application 404. However, in this example a firmware task associated with the second application 404 blocks configuration because partition 1 484 is executing a workload for the first application 402. Execution completes once each of the layers of the machine-learning model, preprocessing graph, or postprocessing graph have been executed. A hardware state of partition 1 438 is cleared and ERT-1 434 yields partition 1 438 to the scheduler 106. The scheduler 106 determines that ERT-2 436 is pending on partition 1 438, and in response sets ERT-2 436 to an execution state and execution of partition-1 438 for a workload of the second application 404 begins. A variety of other examples are also contemplated.

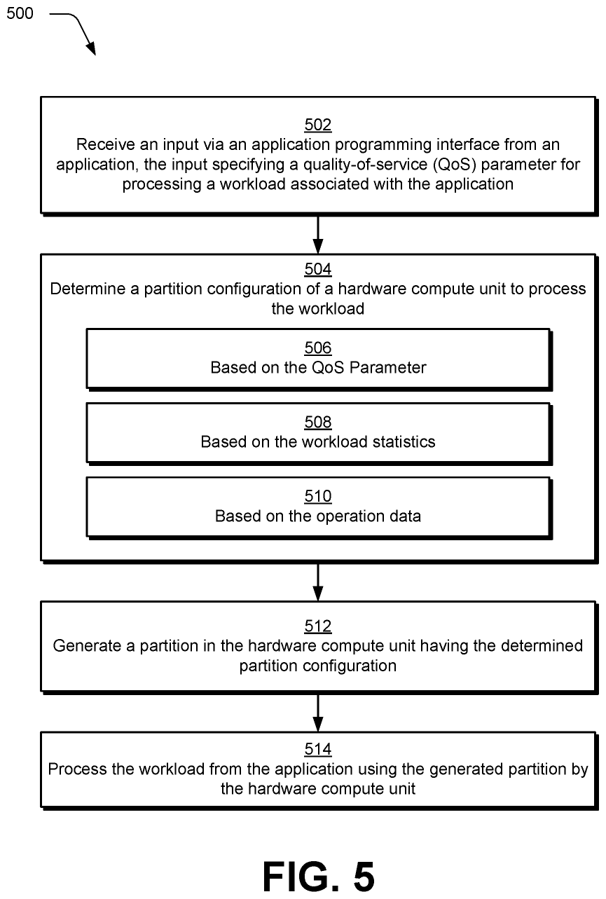

FIG. 5 depicts a procedure 500 in an example implementation of quality-of-service (QoS) partition configuration.

An input is received via an application programming interface from an application. The input specifies a quality-of-service (QoS) parameter for processing a workload associated with the application (block 502). By way of example, a scheduler 106 receives the input 114 including the QoS parameters 118 via a QoS API 120.

A partition configuration of a hardware compute unit is determined to process the workload (block 504). By way of example, the partition is configured based on the QoS parameter 118 (block 506), e.g., latency 210 or throughput 212. By way of another example, the partition is configured based on workload statistics 216 (block 508), e.g., number of operations 218 or data movement 220. By way of a further example, the partition is configured based on operation data 222 (block 510), e.g., describing operation of other partitions, partition availability, priority, and so forth.

A partition is generated in a hardware compute unit having the determined partition configuration (block 512). By way of example, columns of the compute array 110 are allocated by the scheduler 106.

The workload from the application is processed using the generated partition by the hardware compute unit (block 514). By way of example, the workload includes execution of a precompiled machine-learning model 206 via a respective partition 112 to process a digital image 204, e.g., for object recognition. A variety of other examples are also contemplated.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the application 104, scheduler 106, and hardware compute unit 108) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A method comprising:
receiving an input via an application programming interface from an application, the input specifying a quality-of-service (QoS) parameter for processing a workload associated with the application;
determining a partition configuration of a hardware compute unit to process the workload, the determining based at least in part on the QoS parameter;
generating a partition in the hardware compute unit having the determined partition configuration; and
processing the workload from the application using the generated partition by the hardware compute unit.

2. The method of claim 1, wherein the quality-of-service (QoS) parameter defines latency or throughput.

3. The method of claim 1, wherein the determining the partition configuration includes determining a size or clock speed of the hardware compute unit to meet the quality-of-service (QoS) parameter.

4. The method of claim 3, wherein the determining the size includes determining a number of columns in a compute array of the hardware compute unit to be used to process the workload.

5. The method of claim 1, further comprising receiving workload statistics describing the workload and wherein the determining of the partition configuration is based at least in part on the QoS parameters and the workload statistics.

6. The method of claim 5, wherein the workload statistics include a number of operations or data movement.

7. The method of claim 5, wherein the workload statistics are determined based on prior knowledge of implementation of the workload.

8. The method of claim 1, wherein the workload includes execution of a machine-learning model selected from a plurality of precompiled machine-learning models.

9. The method of claim 1, further comprising receiving operation data describing operation of the hardware compute unit and wherein the determining of the partition configuration is based at least in part on the QoS parameters and the operation data.

10. The method of claim 9, wherein the operation data describes operation of another partition by the hardware compute unit.

11. A device comprising:
a hardware compute unit; and
a scheduler configured to:
expose an API that is accessible by an application to specify a quality-of-service (QoS) parameter for processing a workload; and
configure a partition in the hardware compute unit to process the workload based at least in part of the quality-of-service (QoS) parameter.

12. The device of claim 11, wherein the quality-of-service (QoS) parameter defines latency or throughput.

13. The device of claim 11, wherein the scheduler is configured to configure the partition based on a determination of a size or clock speed of the hardware compute unit to meet the quality-of-service (QoS) parameter.

14. The device of claim 13, wherein the scheduler is configured to determine the size as a number of columns in a compute array of the hardware compute unit to be used to process the workload.

15. The device of claim 11, wherein the scheduler is configured to receive workload statistics describing the workload and configure the partition based at least in part on the quality-of-service QoS parameter and the workload statistics.

16. The device of claim 15, wherein the workload statistics include a number of operations and data movement.

17. The device of claim 11, wherein the scheduler is configured to receive operation data describing operation of the hardware compute unit and configure the partition based at least in part on the quality-of-service (QoS) parameter and the operation data.

18. The device of claim 11, wherein the scheduler is configured to configure the partition to minimize power consumption in processing the workload and comply with the quality-of-service parameter.

19. A method comprising:
receiving an input via an application programming interface from an application, the input specifying a quality-of-service (QoS) parameter and workload statistics for processing a workload associated with the application;
determining a partition configuration of a hardware compute unit to process the workload, the determining configured to minimize power consumption in processing the workload based on the workload statistics in compliance with the QoS parameter;
generating a partition in the hardware compute unit having the determined partition configuration; and
processing the workload from the application using the generated partition by the hardware compute unit.

20. The method of claim 19, wherein:
the quality-of-service (QoS) parameter defines latency or throughput; and
the workload statistics include a number of operations or data movement.
